(19) United States
(12) Patent Application Publication
(10) Pub. No.: US 2008/0009989 A1
(43) Pub. Date: Jan. 10, 2008

(54) Operating system for a seat

(76) Inventors: Stephen E. Kim, Valencia, CA (US); Vahik Baghdasarians, Glendale, CA (US); Ashley Green, Arcadia, CA (US); Khalid Muhammad, Newbury Park, CA (US)

Correspondence Address: CHRISTIE, PARKER & HALE, LLP, PO BOX 7068, PASADENA, CA, 91109-7068, US

(21) Appl. No.: 11/726,965

(22) Filed: Mar. 21, 2007

Related U.S. Application Data
(60) Provisional application No. 60/743,606, filed on Mar. 21, 2006.

(51) Int. Cl. G05B 19/00

(52) U.S. Cl. 701/36

(57) ABSTRACT

A vehicle seat system includes a vehicle seat, a main controller, a plurality of hub controllers connected to the main controller, and a plurality of seat devices operatively coupled to the seat. Each seat device is connected to a corresponding one of the hub controllers and operatively coupled to the main controller through the hub controllers. At least two of the seat devices are connected to a single one of the hub controllers.

### RELATED APPLICATION

The present application claims the benefit of U.S. Provisional Patent Application Ser. No. 60/743,606, filed Mar. 21, 2006, the disclosure of which is incorporated herein by reference.

### BACKGROUND

The present application is related to operating systems for vehicle seats, and in particular, to an operating and control system for an airplane seat.

Modern airplane seats, and in particular, seats in the premium sections of passenger airplane are powered and adjustable between a number of seating positions. Some seats may be adjustable from an upright position to a reclined position, while others can recline to a substantially flat position in order to function as a bed. Additionally, some airplane seats have a head rest and a foot rest that can be adjusted to provide a comfortable position for each passenger. The various adjustable features of the seat are accessible and controllable with a passenger control unit, which may be a keyboard-type of input device with a display. The passenger control unit may also provide the passenger with the ability to adjust the environmental conditions around the seat, such as lighting, temperature and the like. Furthermore, the passenger control unit can also allow the passenger to operate various entertainment devices and features associated with the seat.

FIG. 1 illustrates a powered seat S with a seat operating system including a passenger control unit (PCU) such as a keypad 104, a controller 106 and several actuators or other devices 108A-H. A passenger (not shown) sitting in the seat uses the keypad to adjust the seat position and associated devices. The keypad communicates with the controller which, in turn, controls the actuators. The seat controller drives the actuators which control various aspects of the seat. For example, an actuator 108D moves leg rest 110 that moves from a substantially vertical retracted position to a substantially horizontal, extended position. An actuator 108E moves a the foot rest 112, that moves from a substantially extended to a substantially retracted position. An actuator 108A moves the reclining back rest 114 that moves from a substantially vertical position to a substantially horizontal position. An actuator 108C moves the seat pan 116. An actuator 108H moves the privacy screen 118. A lumbar controller 108B drives/controls the lumbar bladder 120. In addition, each actuator may include one or more position determining components such as a transducer or sensor (not shown).

A variety of devices may be associated with a seat. For example, by using the PCU, a passenger may control cabin lighting 108F, video systems 108G, audio systems (not shown) or other devices. For convenience, a device associated with a seat such as an actuator or another device or component mentioned herein may be referred to in the discussion that follows as a “seat device.”

In a conventional seat control system 200 as shown schematically in FIG. 2, all processing is performed in a controller 202. The controller thus directly controls the operation of each actuator or other devices 204A-F. For example, the controller generates control signals for each actuator and other devices and sends these signals to each actuator/device via separate connection leads 206A-G. In addition, any signals from sensors in the actuators are sent directly back to the controller. A relatively substantial amount of wiring is used to connect the components in the example of FIG. 2. Here, the seat controller 202 incorporates five actuators 204A-E with integrated cables and eight interconnect cables 206A-H with associated connectors 208.

In another conventional seat control system 300, as shown in FIG. 3, an actuator controller is incorporated into each actuator assembly 304A-E. Here, a main controller 302 may coordinate the operation and position of all of the actuators. To this end, the main controller sends commands to each actuator controller over a common serial bus 306 (including leads 306A-G) to accomplish the desired actuation. Through the use of a common serial bus, the amount of wiring associated with the seat controller may be reduced as compared to the embodiment of FIG. 2. In the example of FIG. 3, the seat controller incorporates seven interconnect cables 306A-G with associated connectors 308.

Each actuator controller controls the position of an associated actuator based on commands from the main controller. In response to a command for a given actuator, a corresponding actuator controller generates, within the actuator assembly, actuation signals for that actuator. Signals from sensors in an actuator are sent to the associated actuator controller in the actuator assembly. The actuator controller may use these sensor signals to verify the movement or position of the actuator.

The main controller may perform various functions in addition to the motion control functions described above. For example, the main controller may include a user interface (HMI), communication management, power management and test (e.g., built-in test equipment) functionality. The actuator controller may perform various functions relating to the motion control functions described above. For example, the actuator controller may include a motor driver, actuator jam and short circuit control functionality and electronic clutch abuse control functionality. In addition, the actuator controller may include communication and test (e.g., built-in test equipment) functionality.

In both of the above-described systems, excessive wiring is used to connect the actuators to the main controller. Because the location of the main controller may be far from some or all the actuators, the amount of wire used to connect the controller to the actuators may be excessive. Furthermore, older seats with legacy actuators cannot be easily retrofitted for use with new or improved controllers and control algorithms. In such circumstances, replacement of the legacy actuators with actuators which can be controlled with the new controller may be necessary.

Based on the above, there is a need for an operating or control system for a vehicle seat that provides improved wiring, modularity and upgradeability.

### SUMMARY

In accordance with one aspect of the disclosure, an operating system for a vehicle seat includes a main controller, at least one hub controller connected to the main controller, and a plurality of seat devices, each seat device connected to the hub controller and operatively coupled to the main controller through the hub controller.

In accordance with another aspect of the disclosure, an operating system for a vehicle seat includes a main controller, a plurality of hub controllers connected to the main controller, and a plurality of seat devices. Each seat device is connected to a corresponding one of the hub controllers and operatively coupled to the main controller through the hub controllers. At least two of the seat devices are connected to a single one of the hub controllers.

In accordance with another aspect of the disclosure, a vehicle seat system includes a vehicle seat, a main controller, a plurality of hub controllers connected to the main controller, and a plurality of seat devices operatively coupled to the seat. Each seat device is connected to a corresponding one of the hub controllers and operatively coupled to the main controller through the hub controllers. At least two of the seat devices are connected to a single one of the hub controllers.

In accordance with another aspect of the disclosure, a method of operating a vehicle seat includes communicating between a main controller and at least one hub controller of a plurality of hub controllers connected to the main controller, and operating at least one seat device of a plurality of seat devices connected to the at least one hub controller responsive to the communication between the main controller and at the at least one controller.

### BRIEF DESCRIPTION OF THE DRAWINGS

FIG. 1 shows a schematic view of a vehicle seat according to the disclosure.

FIG. 2 shows a schematic diagram of a prior art system for a vehicle seat.

FIG. 3 shows a schematic diagram of another prior art system for a vehicle seat.

FIG. 4 shows a schematic diagram of a vehicle seat operating system according to the disclosure.

FIG. 5 shows a block diagram of a main controller and a hub controller according to the disclosure.

FIG. 6 shows a block diagram of an operation of a vehicle seat operating system according to the disclosure.

FIG. 7 shows a schematic diagram of an example of a seat device being operable by the vehicle seat operating system according to the disclosure.

FIG. 8 shows a schematic diagram of another example of a seat device being operable by the vehicle seat operating system according to the disclosure.

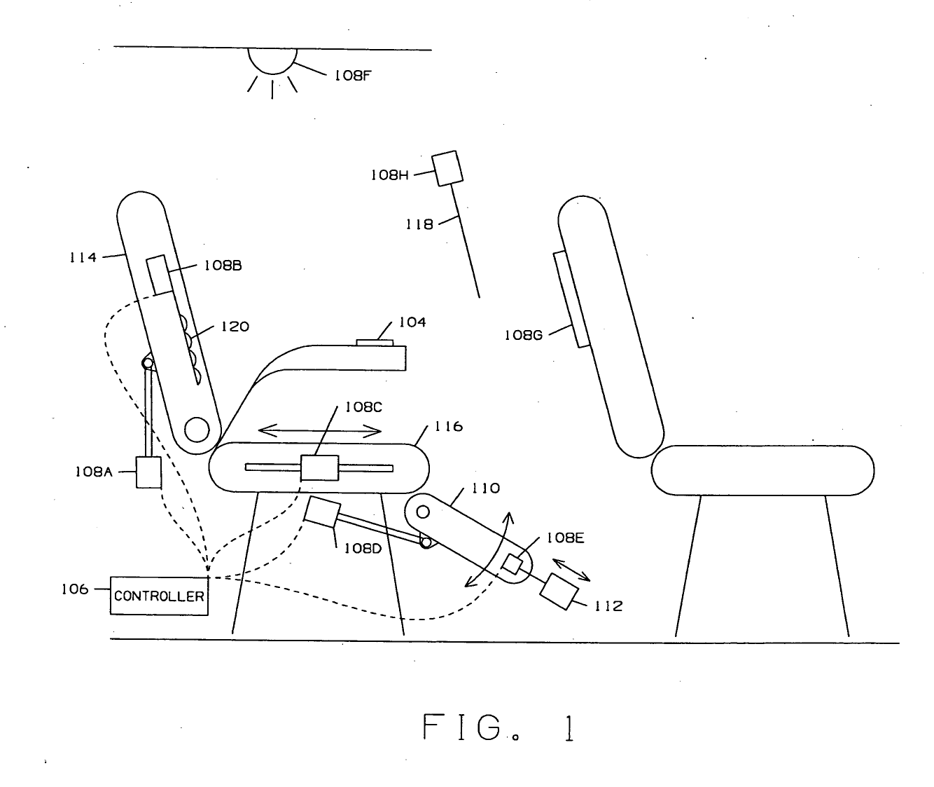

### DETAILED DESCRIPTION

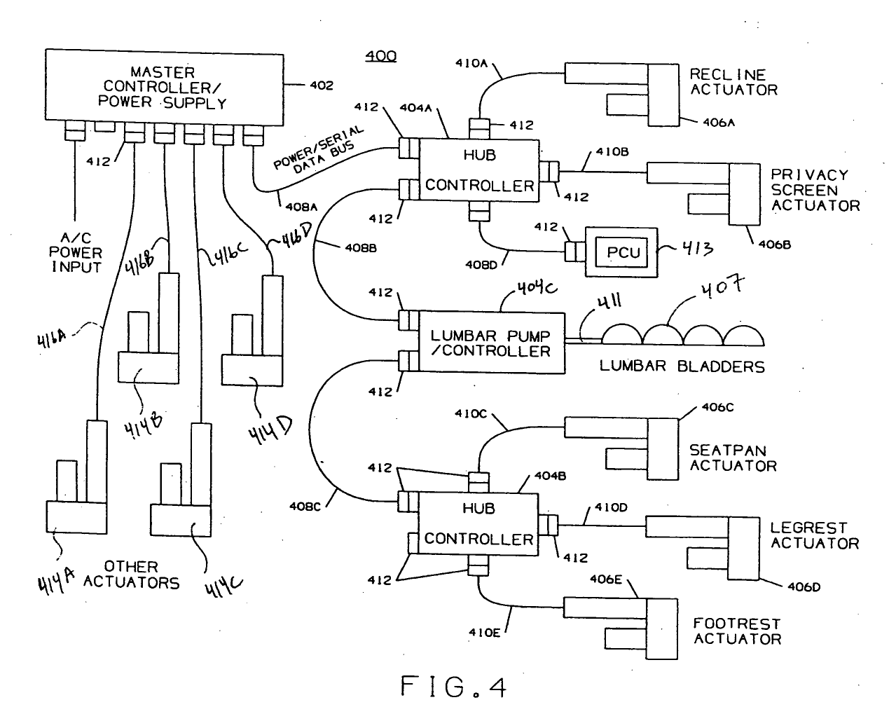

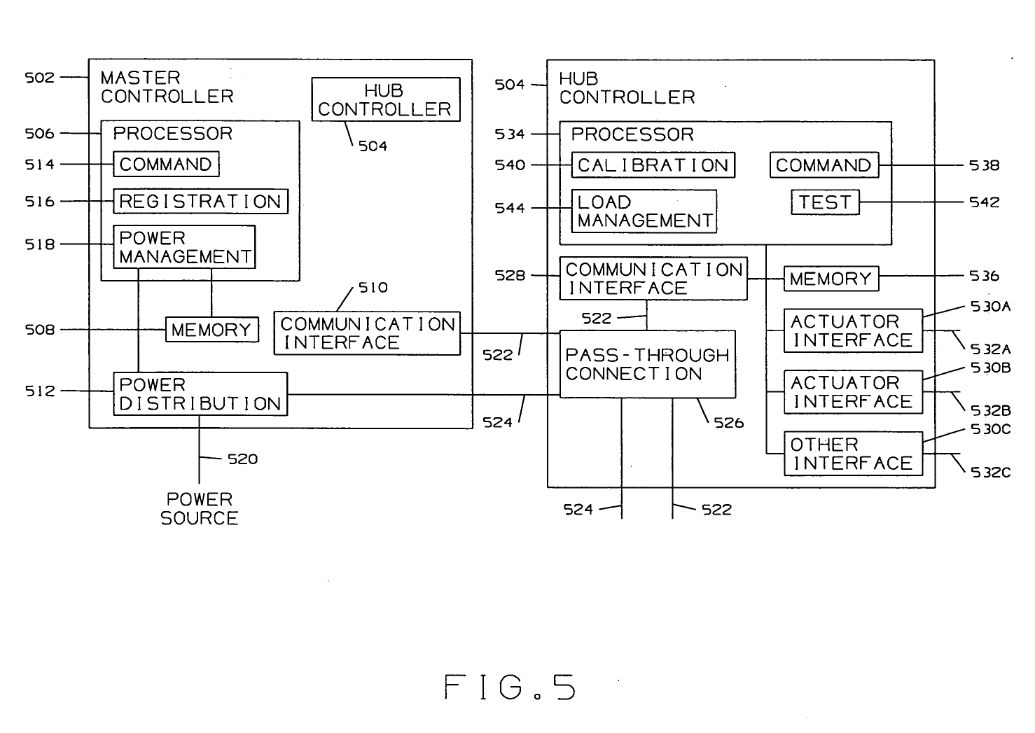

Referring to FIGS. 4 and 5, a vehicle seat operating system 400 according to the disclosure is shown. The seat operating system 400 includes a main controller 402 which cooperates with several hub controllers 404A-404C to control several seat devices 406A-406E and 407. Each of the hub controllers 404A-404C can control one or several seat devices 406A-406E and 407. In the disclosure, exemplary seat devices are shown as actuators 406A-406E and lumbar bladders 407. However, “seat devices” as used herein refers to any device associated with the seat and the environmental conditions in the area proximate to the seat (i.e., lighting, climate, entertainment devices).

The main controller 402 can send commands to each hub controller 404A-404C over a common serial bus 408 (including leads 408A-D) to accomplish the desired actuation. In response to commands for an associated actuator, a hub controller (e.g., hub controller 404A) generates actuation signals for the associated actuator (e.g., actuator 406B). The hub controller sends the actuation signals to the actuator via an associated connection lead (e.g., lead 410B). The hub controller can use a separate connection lead (e.g., lead 410A and 410B) to communicate with each actuator (e.g., actuators 406A and 406B). The lumbar pump/controller 404C can pneumatically communicate with the lumbar bladders 407 through a pneumatic conduit 411.

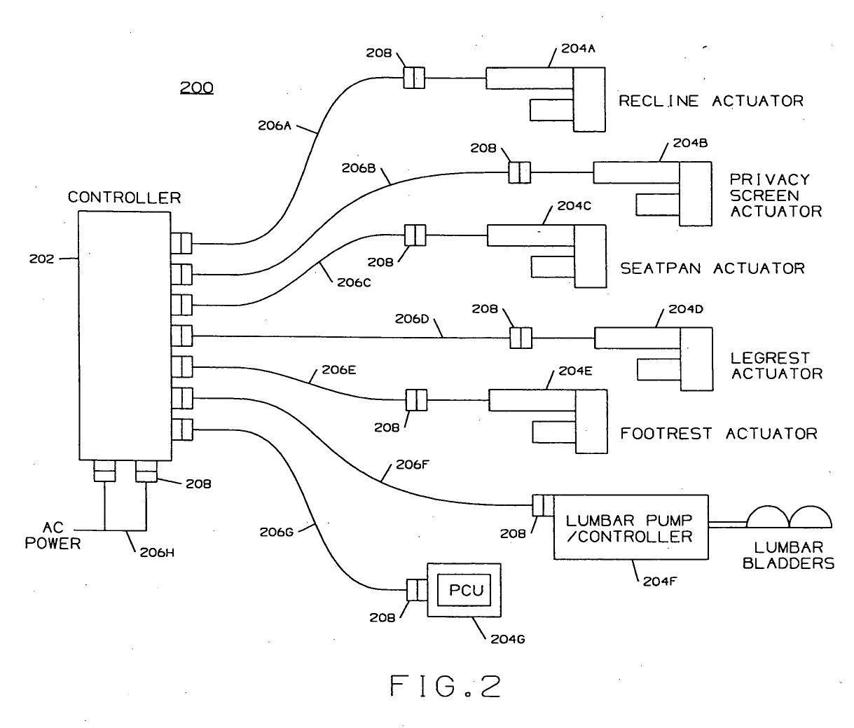

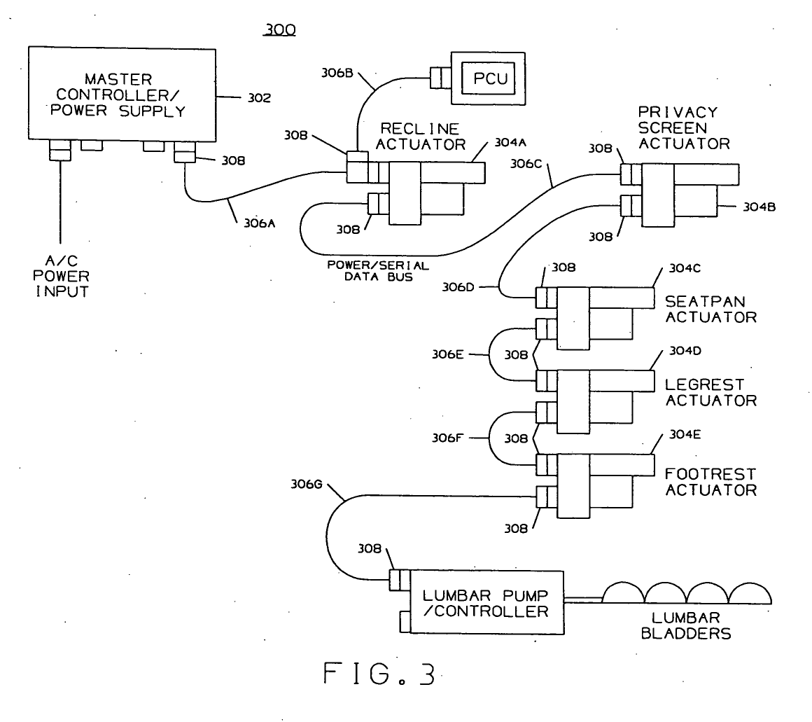

The main controller 402 may be connected to the hub controllers 404A-404C, which control additional actuators 406A-E, using integrated cables 410A-E and four interconnect cables 408A-C with associated connectors 412. However, since the hub controllers may be placed in relatively close proximity to the actuators, the amount of wiring associated with the seat controller may be reduced as compared to the control system of FIG. 2.). The hub controllers 404A-404C may be used to control conventional actuators via conventional actuator signals. As a result, improved functionality and reduced wiring may be provided in legacy seats without requiring replacement of the legacy actuators. Conventional signals from sensors in actuators may be sent to the associated hub controller via the associated connection lead. The hub controller may process the sensor signals to control the actuator. The hub controller also may send data derived from the sensor signals to the main controller

In the example of the seat operating system 400 of FIG. 4, the main controller 402 can also directly operate four actuators 414A-D using cables 416A-D without any hub controllers. The actuators 414A-D may be the type that do not have an integrated controller so as to be directly controlled by the main controller 402. The actuators 414A-D may also be of the type that have integrated controllers which communicate with the main controller 402.

The main controller 402 can control and monitor all of the actuators and other devices associated with the seat. Here, the main controller 402 may coordinate operation of all of the actuators. For example, the main controller may prevent a given actuator from being moved to certain positions (e.g., related to safety zones) depending on the position of one or more other actuators.

Additional details of one embodiment of operations of the seat operating system 400 of FIG. 4 will be described in conjunction with FIG. 5. FIG. 5 illustrates select components of one embodiment of a main controller 502 in communication with one embodiment of a hub controller 504. The main controller 502 includes a processor 506, a data memory 508, a communication interface 510, and incorporates all of the functionality of the hub controller 504. In addition, the main controller 502 may include a power distribution component 512 to supply power from a main power source to the other components of the seat controller.

A variety of data may be stored in the data memory 508. The data memory 508 stores execution code for the processor 506. The data memory 508 also may store data associated with the hub controllers, the actuators and other devices. This information may include, for example, configuration, calibration and test information. General and special software drivers also may be stored in the memory. The data memory may store a mathematical model of the seat kinematics and dynamics which governs the motion of the seat. In addition, safety zones for the actuators and seat may be stored in memory.

As discussed above, the main controller 502 can recognize safety zones for the actuators and prevents a zone from being violated. Safety zones account for physical interference between various moving seat components and also with external objects, e.g., the floor or other seats. In one embodiment, the safety zones are defined in memory using Cartesian coordinates in a predefined mathematical model. In another embodiment, the safety zones are learned using fuzzy logic techniques. Additionally, travel limits for the actuators and system end limits are defined by a calibration process. Examples of safety zones are provided in U.S. Pat. Nos. 5,651,587, 5,755,493 and 5,887,949, the disclosures of each of which are hereby incorporated by reference.

In one embodiment, the processor 506 includes a command module 514. The command module is configured to query or poll each actuator, hub controller, etc., to obtain real-time information, for example, positional, speed or diagnostic information. Furthermore, the command module 514 commands the actuators (via the hub controllers) to move the seat using mathematical algorithms, models and safety zones from the memory and using the real-time information (e.g., sensor data) from the actuators. In one embodiment, the command module 514 interprets the real time information and transmits some or all of the information to the passenger control unit (PCU) 413 (shown in FIG. 4). Upon receipt of the information, the PCU 413 can present the information to the user, for example, a graphical display representing the seat moving in a particular direction and speed. The command module 514 also utilizes the information to monitor the actuators, hub controllers, etc., for potential errors or usage data or to log and store the information in memory.

The processor 506 also may include a registration module 516. The registration module 516 maintains a record of all the actuators, hub controllers, etc., and addresses or location of these components in the system. Additionally, the registration module 516 can identify when a component is added to or removed from the system. In conjunction with the command module 514, the registration module 516 can also recognize and record when a component is not operational or otherwise not to be utilized.

The processor 506 also may include a power management module 518. Power is supplied to the seat controller via a power line 520 from a power source such as a power supply. In one embodiment, the power supply is a constant DC source, e.g., a 24 or 28 volts direct current (VDC) source to minimize electromagnetic interference (EMI). In one embodiment, power supplied to the seat controller is provided by a master power supply or a seat subsystem power supply (not shown) that powers all the aircraft seat devices. In one embodiment, power supplied to the seat controller is provided by a local power supply that also powers another component in an aircraft.

The power management module may manage the power supplied to the seat controller components. For example, the main controller 502 may monitor (e.g., via requests to the hub controllers) the power consumption of each actuator or the power consumption of all actuators (e.g., via the power distribution component 512). When a threshold level (e.g., a predetermined limit) of the power consumption for a given actuator or a threshold level of the total power consumption of the actuators is exceeded, the main controller (e.g., via commands to the hub controllers) reduces the speed of or turns off one or more of the actuators. Such a threshold may be exceeded, for example, when a seat component (e.g., a leg rest) being moved by an actuator has encountered an external object (e.g., a piece of luggage in front of the seat).

The communication interface 510 couples the main controller to a serial communication line 522 to receive and transmit information from and to the hub controllers, actuators, etc. The communication interface 510 similarly couples the main controller 502 to the passenger control unit 413 to receive from and transmit information to the passenger control unit 413. In one embodiment, the communication interface 510 controls the serial communication line or network. For example, all of the other devices connected to the serial communication line may simply respond to commands, requests, etc., from the main controller.

The communication interface 510 supports the particular protocol and/or physical interface used to implement the serial communication line. For example, the serial communication line may include a RS-485, CAN, TCP/UDP or Fieldbus serial interface.

In one embodiment, a power line 524 and the serial communication line 522 between the main controller 502 and the hub controllers 504 are integrated as a single line, link, bus or network connection. The network connection may be a single shielded cable that includes wires for positive and negative power, positive and negative data and a safety ground.

In one embodiment, the components are connected to the network using T-tap connections that provide branches in the line to allow components access to power and data. As such, the line is adapted to utilize standardized cables and connections and thus is simple and occupies minimal amounts of space.

In one embodiment, the network includes pass-through connections. The pass-through connections allow data and power to be supplied to the components and data to be sent from the components without significant or any modification or interference by any particular component. Through the use of pass-through connections on the network, the components may be coupled in a daisy chain or star configuration or a combination of both configurations. As a result, the network may have shorter overall and simplified wiring harnesses, which in turn may reduce cost, wire gauge and EMI emissions. In one embodiment, the wiring harness is constructed from standardized cable segments with a minimum number of routed wires.

The hub controller 504 can include a pass-through connection 526 and a communication interface 528. The communication interface 528 may include a transceiver (not shown) for interfacing with the serial communication line. In one embodiment, the transceiver is a tri-state two wire transceiver supporting (half duplex or full duplex) bi-directional communication between the components on the line.

The hub controller 504 includes several components (e.g., actuator driver circuits) for interfacing with each of the actuators or other devices connected to the hub controller 504. These components include separate or combined logic and other circuitry for controlling each of the actuators, etc., in cooperation with the main controller 502. To this end, these components generate signals to control the actuators, etc., and receive status signals from the actuators, etc.

The hub controller 504 may include appropriate signal interface components 530A-530C to send signals to (as represented by lines 532A-532C) and receive signals from (as represented by lines 532A-532C) the actuators or other devices (not shown in FIG. 5). These components may include, for example, separate line drivers and receivers for each actuator. The actuator driver circuits may use fixed connections, addressing or some other mechanism to interface with the appropriate line drivers and receivers to send signals to and receive signals from the desired actuator, etc. In one embodiment addressing of the hub controllers 404A-C can be done in the harness 408 A-C (as shown in FIG. 4).

As shown by the embodiment of FIG. 5, the components of the hub controller 504 may be implemented using one or more processors 534. For example, the processor 534 may interact with the communication interface 528 to send and receive messages and data. In addition, the components of the hub controller 504 associated with each actuator or other device may be implemented using one or more processors.

The functionality associated with a given component may be defined by code, commands and other data stored in a data memory 536. Thus, separate code and data may be associated with each component. In one embodiment, a hub controller 504 may store its own configuration, calibration and/or test information in the data memory.

The processor 534 may thus formulate commands and supply data parameters to the actuators, etc., that cause a device to perform a particular function or functions. For example, the processor may generate signals that cause a motor to start or move a gear. To this end, the processor 534 may include a command module 538. The command module 538 interprets the commands or instructions, e.g., a program, and the associated data from the main controller 502 or the other components to manipulate the seat. In one embodiment, the command module 538 determines and utilizes the appropriate codes, e.g., machine code, signals, e.g., providing a specific voltage or current, or data storage, e.g., writing to a particular bit in a memory element, such as a register, to manipulate a seat in accordance with the commands from the main controller 502.

The processor 534 may further include a calibration module 540 to calibrate the seat devices. For example, the calibration module 540 defines the start and end points or additional points along an axis. In one embodiment, the passenger control unit provides or sets end points for or used by the calibration module 540 in a production situation. For instance, the seat devices are manually operated or the passenger control unit 413 causes the calibration module 540 to move the aircraft seat devices in a particular direction or to a specific position. When the aircraft device reaches the specified position or is stopped by the passenger control unit via the calibration module 540, and, in one embodiment, upon receipt of a command from the passenger control unit 413, the calibration module 540 records the position of the aircraft seat device as an end point or limit.

In another embodiment, the calibration module 540 is self-contained and thus calibrates the actuators, etc., without needing or using external equipment. For example, the calibration module 540 activates a seat device, the seat device then operates until a hard stop or limit, i.e., an inherent limit property of the seat device is reached. An example of a hard stop is a point where a motor will stop turning even if the motor is commanded to turn. The calibration module 540 records the hard stop or a location before the hard stop, e.g., a few turns before the stop, as an endpoint or limit. In one embodiment, the passenger control unit is used to further refine the limits after the calibration module 540 performs an initial self-calibration. Therefore, the calibration module 540 is able to compensate for variations in the aircraft seat and seat devices by calibrating the aircraft seat devices with or without interaction or input from an external source.

The processor 534 may further include a test module 542. The test module 542 provides test sequences or commands to poll, detect or identify potential problems or errors in the hub controller or in a seat device. The test module also may log or record errors and usage data in the data memory. In one embodiment, the test module reports the errors to the main controller or another component. The test module, in one embodiment, also includes built in test equipment that provides self contained tests and diagnostic capabilities of the hub controller and/or actuator. For example, the built in test equipment detects actuator failures due to over-current, overheating or excessive mechanical loads without using external equipment. The built in test equipment also collects data on various components associated with the hub controller, actuators, etc., that effect the operating lifetime of the components. Thus, the built in test equipment or test and calibration module 540 may obviate the need for external test and calibration equipment.

The processor 534 also may include a load management module 544. The load management module 544 records power being consumed by the seat devices. In one embodiment, the load management module causes the hub controller to power down a seat device when a predetermined condition occurs, such as when a seat device is not in use or when an error is detected in the seat device. In one embodiment, the load management module self limits or budgets power consumption based on a limit provided from the main controller.

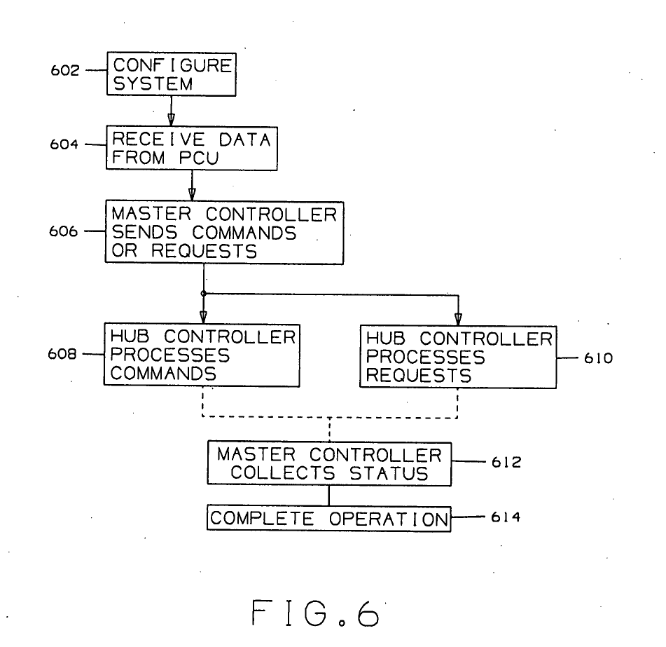

Additional details of one embodiment of operations of the seat controller of FIG. 4 will be described in conjunction with the flowchart of FIG. 6. These operations commence with configurations operations as represented by block 602.

In some embodiments the main controller may configure the hub controllers and other devices. For example, the main controller may send a command to the hub controller that includes configuration data, parameters, code to be executed by the hub controller, etc. The main controller also may update the code and other data stored in the hub controllers.

In some embodiments the main controller may automatically determine which hub controllers and or actuators are installed and/or operating properly in the seat controller. This may involve, for example, polling for hub controllers connected to the communication line. As new components are added, the main controller may poll for the attributes of the components and/or configure the components as necessary.

In one embodiment, in sharing information between the hub controllers and the main controller, the hub controllers and the main controller follow a system level network protocol. This allows a hub controller or associated component to be added or removed from the system without performing a re-design of the system controls or software. As such, adding a more powerful or improved actuator, pump, valve, or other device, for example, in a revised application, is accomplished by disconnecting the device and replacing the device with the new device. Any additional programs and drivers required by the hub controller may be transferred to the hub controller from the main controller. No re-engineering of the system controls and software is needed to integrate the new device. In one embodiment, the main controller is also removable or detachable from the system, for example, in systems requiring simple control.

Once the system is configured, as represented by block 604 the main controller may poll or wait for signals (e.g., using interrupts) from the passenger control unit. In this way, the main controller may issue the appropriate commands or requests to initiate the action requested by the passenger.

As represented by block 606, the main controller may then send a command or request to a hub controller. For example, the main controller may instruct the hub controller to move a given actuator to a given position. In this case, the message may include an indicator (e.g., an address) of the hub controller and an indicator (e.g., an address) of an actuator. In addition, the main controller may poll the hub controller to determine the prior and/or current operational status of the actuators, the hub controller, etc.

As represented by block 608, in response to an appropriate command the hub controller may generate appropriate signals to control an associated device such as an actuator, a light device, a passenger control unit, etc. For example, the hub controller may cause the actuator to move and may monitor status signals received from the actuator. In conjunction with the operation the hub controller may provide safety functions such as over-current (short circuit protection) and jam protection (actuator force limit). In one embodiment the hub controller incorporates motor speed detection utilizing a back electromagnetic field (EMF) signal or differentiating the position feedback signal. In addition, the hub controller may send status data regarding the operations back to the main controller

Similarly, as represented by block 610, in response to an appropriate request the hub controller may send status or other data regarding an actuator or the hub controller back to the main controller. Here, the hub controller may determine the operational status of an associated device in real-time. For example, the hub controller may generate appropriate signals to cause a specified actuator or actuators to send status or other information. Alternatively, the hub controller may obtain status or other information from sensed signals or from a data memory. In the latter case, the information may have previously been collected by the hub controller and stored in data memory for subsequent use. Such information may be obtained, for example, through the use of the test capabilities (e.g., BITE) of the hub controller.

As represented by block 612, in conjunction with the above operations the main controller may send commands or requests to the hub controller to determine the status of the operations and/or the operational status of components involved in the operations. Such information may be used, for example, to ensure that safety zones are not violated. Such information also may be used to monitor the progress of an operation. Thus, if an operation (e.g., actuator movement to a specified location) has not occurred within an expected time period the main controller may terminate the operation or take other steps to resolve the problem.

As represented by block 614, the main controller may then send additional commands or requests to the hub controller to complete the desired operation. Here, status information received from a hub controller may indicate that the desired result has been achieved or that an error has occurred. In the latter case, the main controller may take appropriate corrective action.

Although the processes above describe actions being taken in a particular order, the actions could be performed in many different orders and combinations based on the intended functionality or application of the system. Additionally, the main controller may command the hub controllers to perform additional and alternative actions then those described above. Also, the main controller may simultaneously invoke operations for multiple devices (e.g., actuators) controlled by the same or different hub controllers. Accordingly, multiple components of the seat may be caused to move simultaneously in a coordinated manner. To coordinate this movement, the controller may process, in real-time, status information (e.g., actuator position, speed, etc.) received from the hub controllers, actuators, etc., to adjust actuator speeds, change which actuators are being moved at a given time, etc.

It should be appreciated that the teachings herein may be used to manipulate a variety of seat devices such as seat actuators, pneumatic lumbar systems, lamp drivers, telemetry devices, sensors, solenoids, switches, power supplies, input devices, etc. Various types of actuators of various sizes and configurations including, for example, brush, brushless, stepper motors, air valves and pumps, may be used in a seat. Typically the actuators are generally packaged in a form that corresponds to their function, e.g., linear actuators are produced in standard stroke lengths, or are provided in a modular and standardize form. The actuators may have internal drive electronics, e.g., pulse width modulation (PWM) circuitry, which being near, for example, a stepper motor minimizes EMI, as opposed to the drive electronics being placed away from the actuator, such as at the end of a cable. In one embodiment, the actuators also have internal feedback limiters that regulate the maximum amount of, for example, current, the actuator is able to utilize. The hub controller may thus be configured to monitor and return real time or stored data on speed, direction, force, pressure, voltage, current, resistance and temperature about such actuators.

In one embodiment a passenger control unit communicates with the main controller and/or a hub controller utilizing a serial communication architecture. In the passenger control unit each key may constitute a sensor; with each sensor having associated programmed functions. Such functions may, for example, activate lights, a lumbar controller, an actuator or several actuators in sequence.

Provisions may be made to protect any actuator or any structure of a seat from potentially damaging forces (e.g., excessive stress). For example, if a person stands on a cantilevered leg rest that is in an extended position, the resulting force on the actuator may damage the actuator. To address this problem an actuator may be provided with an electronic clutch. Here, the actuator may consist of a load cell, a strain gauge or similar sensing device at the output shaft or its support or as an alternative such device may be embedded in the seat structure. In one embodiment the associated hub controller processes signals from the sensing device to determine the load on the actuator and energizes the brake when the load exceeds the threshold value allowing actuator to override. The brake is re-engaged by removing the power when the load is reduced, for example, below the set value.

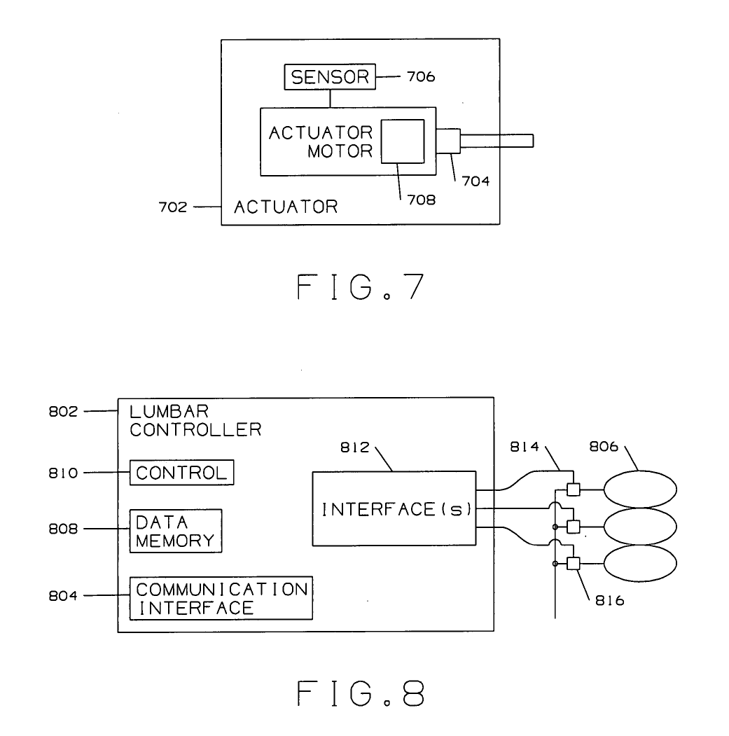

FIG. 7 illustrates one embodiment of an actuator 702 incorporating an electronic abuse clutch. In one embodiment this feature is implemented in a linear actuator. The electronic abuse clutch may include a load sensor 704, a signal processor 706 (e.g., in the actuator or as discussed above in an associated hub controller), and a brake circuit 708. The load sensor may be located in the lead screw support area such as in the drive gear or bearing block. A threshold load level may be programmed in a data memory for the actuator controller (e.g., hub controller). When the load reaches the threshold load in the actuator the controller energizes the brake circuit releasing the brake. This allows the actuator to release the load by traveling with the load. The controller removes the power from the brake circuit as the load on the actuator reduces below the threshold value. A dead band and tolerance band (e.g., stored in data memory) may be utilized for the threshold force to ensure smooth operation of this feature.

FIG. 8 illustrates one embodiment of a lumbar bladder controller 802. The lumbar controller may utilize a serial communication interface 804 to communicate with the main controller and/or a hub controller (not shown in FIG. 8). The lumbar controller may use predefined sequences for inflating and deflating lumbar bladders 806 thus creating a massage like function for the passenger. To this end the lumbar controller may include a data memory 808 for storing one or more inflation/deflation sequences. In addition, the lumbar controller may include control logic (e.g., a processor and code) 810 and signal interfaces 812 for generating signals 814 in accordance with the sequences to control one or more valves or inflation or deflation devices 816 associated with the lumbar bladders 806. Such techniques may be used for a variety of bladder-type structures. In some embodiments the bladder(s) may consist of lumbar bladders loaded in a back rest of a seat. In some embodiments the bladder(s) may be provided in a seat pan and/or leg rest to affect the legs (e.g., lower thighs) of a passenger. In some embodiments the bladder(s) may be provided as an inflatable/deflatable external unit that the passenger may wrap around his or her legs, etc. Such an external unit may thus plug into or otherwise attach to a controller such as the one shown in FIG. 8. Accordingly, such techniques may provide a form of preventative or other treatment for deep vein thrombosis (DVT).

Different embodiments of the disclosure may include a variety of hardware and software processing components. In some embodiments of the disclosure, hardware components such as controllers, state machines and/or logic are used in a system constructed in accordance with the disclosure. In some embodiments code such as software or firmware executing on one or more processing devices may be used to implement one or more of the described operations.

The signals discussed herein may take several forms. For example, in some embodiments a signal may comprise electrical signals transmitted over a wire, light pulses transmitted through an optical medium such as an optical fiber or air, or RF waves transmitted through a medium such as air, etc. As used herein, a signal may comprise more than one signal. For example, a signal may consist of a series of signals. A group of signals may be collectively referred to herein as a signal. Signals as discussed herein also may take the form of data. For example, in some embodiments an application program may send a signal to another application program. Such a signal may be stored in a data memory.

In summary, the disclosure generally relates to an improved seat controller. While certain exemplary embodiments have been described above in detail and shown in the accompanying drawings, it is to be understood that such embodiments are merely illustrative of and not restrictive of the broad disclosure. In particular, it should be recognized that the teachings of the disclosure apply to a wide variety of systems and processes. It will thus be recognized that various modifications may be made to the illustrated and other embodiments of the disclosure described above, without departing from the broad inventive scope thereof. In view of the above it will be understood that the disclosure is not limited to the particular embodiments or arrangements disclosed, but is rather intended to cover any changes, adaptations or modifications which are within the scope and spirit of the disclosure as taught herein.

What is claimed is:

1. An operating system for a vehicle seat comprising:
a main controller;
at least one hub controller connected to the main controller; and
a plurality of seat devices, each seat device connected to the hub controller and operatively coupled to the main controller through the hub controller.

2. The operating system of claim 1, wherein the seat devices comprise any one of mechanical actuators and pneumatic actuators.

3. The operating system of claim 1, further comprising a passenger control unit operatively coupled to the main controller and the hub controller.

4. The operating system of claim 1, the main controller comprising a processor, memory and a communication interface configured to communicate with the hub controller and the seat devices.

5. The operating system of claim 1, wherein the hub controller comprises a processor, memory and a communication interface configured to communicate with the main controller and the seat devices.

6. An operating system for a vehicle seat comprising:
a main controller;
a plurality of hub controllers connected to the main controller; and
a plurality of seat devices, each seat device connected to a corresponding one of the hub controllers and operatively coupled to the main controller through the corresponding hub controller;
wherein at least two of the seat devices are connected to a single one of the hub controllers.

7. The operating system of claim 6, wherein the hub controllers are serially connected to the main controller.

8. The operating system of claim 6, wherein the seat devices comprise any one of mechanical actuators and pneumatic actuators.

9. The operating system of claim 6, further comprising a passenger control unit operatively coupled to the main controller and the hub controllers.

10. The operating system of claim 6, the main controller comprising a processor, memory and a communication interface configured to communicate with the hub controllers and the seat devices.

11. The operating system of claim 6, wherein any one of the hub controllers comprises a processor, memory and a communication interface configured to communicate with the main controller and the seat devices.

12. A vehicle seat system comprising:
a vehicle seat;
a main controller;
a plurality of hub controllers connected to the main controller; and
a plurality of seat devices operatively coupled to the seat, each seat device connected to a corresponding one of the hub controllers and operatively coupled to the main controller through the hub controllers;
wherein at least two of the seat devices are connected to a single one of the hub controllers.

13. The vehicle seat system of claim 12, wherein the hub controllers are serially connected to the main controller.

14. The vehicle seat system of claim 12, wherein the hub controllers are serially connected to the main controller.

15. The vehicle seat system of claim 12, further comprising a passenger control unit operatively coupled to any one of the main controller and any one of the hub controllers.

16. The vehicle seat system of claim 12, wherein the seat devices are operatively coupled to moveable portions of the vehicle seat.

17. The vehicle seat system of claim 12, wherein the seat devices are located in proximity to the vehicle seat.

18. A method of operating a vehicle seat comprising:
communicating between a main controller and at least one hub controller of a plurality of hub controllers connected to the main controller; and
operating at least one seat device of a plurality of seat devices connected to the at least one hub controller responsive to the communication between the main controller and at the at least one controller.

19. The method of claim 18, wherein operating the at least one seat device comprises operating the seat device by the main controller communicating the seat device through the hub controller.

20. The method of claim 18, wherein operating the at least one seat device comprises operating the seat device by the at least one hub controller.

21. The method of claim 18, further comprising receiving commands by the main controller from a passenger control unit.

22. The method of claim 18, further comprising receiving commands from a passenger control unit and processing the commands by any one of the main controller and the at least one hub controller prior to operating the at least one seat device.

23. The method of claim 18, further comprising receiving a status information from the at least one seat device and communicating the status information between the main controller and the at least one hub controller.
